(19) United States
(12) Patent Application Publication
(10) Pub. No.: US 2007/0120896 A1
(43) Pub. Date: May 31, 2007

(54) Drop generator

(75) Inventors: Terrance L. Stephens, Molalla, OR (US); Dan Massopust, Sisters, OR (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/289,889

(22) Filed: Nov. 30, 2005

(51) Int. Cl. B41J 2/045

(52) U.S. Cl. 347/68; 347/70

(57) ABSTRACT

A drop generator including a pressure chamber defined by a chamber wall structure, a diaphragm plate disposed on the chamber wall structure and covering the pressure chamber, a piezoelectric transducer attached to the diaphragm plate, and a recess formed in the diaphragm plate and underlying an associated peripheral portion of the piezoelectric transducer such that the associated peripheral portion overhangs the recess.

### BACKGROUND

The subject disclosure is generally directed to drop emitting apparatus including, for example, drop jetting devices.

Drop on demand ink jet technology for producing printed media has been employed in commercial products such as printers, plotters, and facsimile machines. Generally, an ink jet image is formed by selective placement on a receiver surface of ink drops emitted by a plurality of drop generators implemented in a printhead or a printhead assembly. For example, the printhead assembly and the receiver surface are caused to move relative to each other, and drop generators are controlled to emit drops at appropriate times, for example by an appropriate controller. The receiver surface can be a transfer surface or a print medium such as paper. In the case of a transfer surface, the image printed thereon is subsequently transferred to an output print medium such as paper.

### BRIEF DESCRIPTION OF DRAWINGS

FIG. 1 is a schematic block diagram of an embodiment of a drop-on-demand drop emitting apparatus.

FIG. 2 is a schematic block diagram of an embodiment of a drop generator that can be employed in the drop emitting apparatus of FIG. 1.

FIG. 3 is a schematic elevational view of an embodiment of an ink jet printhead assembly.

FIG. 4 is a schematic cross-sectional view of an embodiment of a drop generator.

FIG. 5 is a schematic view of an embodiment of a drop generator.

FIG. 6 is a schematic view of another embodiment of a drop generator.

### DETAILED DESCRIPTION

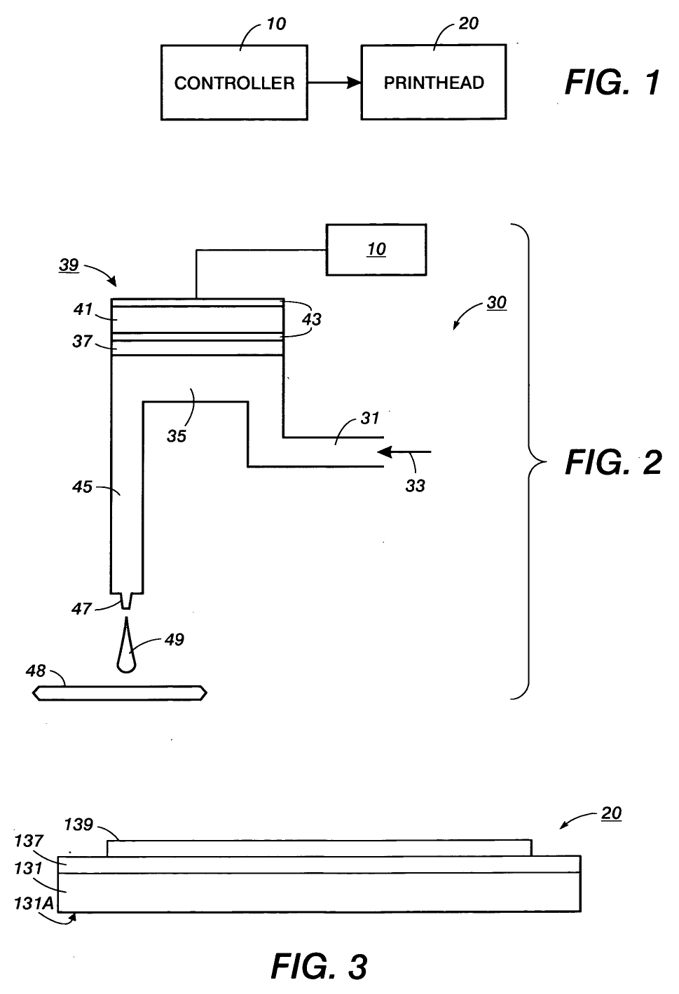

FIG. 1 is a schematic block diagram of an embodiment of a drop-on-demand printing apparatus that includes a controller 10 and a printhead assembly 20 that can include a plurality of drop emitting drop generators. The controller 10 selectively energizes the drop generators by providing a respective drive signal to each drop generator. Each of the drop generators can employ a piezoelectric transducer. As other examples, each of the drop generators can employ a shear-mode transducer, an annular constrictive transducer, an electrostrictive transducer, an electromagnetic transducer, or a magnetorestrictive transducer. The printhead assembly 20 can be formed of a stack of laminated sheets or plates, such as of stainless steel.

FIG. 2 is a schematic block diagram of an embodiment of a drop generator 30 that can be employed in the printhead assembly 20 of the printing apparatus shown in FIG. 1. The drop generator 30 includes an inlet channel 31 that receives ink 33 from a manifold, reservoir or other ink containing structure. The ink 33 flows into an ink pressure or pump chamber 35 that is bounded on one side, for example, by a flexible diaphragm 37. An electromechanical transducer 39 is attached to the flexible diaphragm 37 and can overlie the pressure chamber 35, for example. The electromechanical transducer 39 can be a piezoelectric transducer that includes a piezo element 41 disposed for example between electrodes 43 that receive drop firing and non-firing signals from the controller 10. Actuation of the electromechanical transducer 39 causes ink to flow from the pressure chamber 35 through an outlet channel 45 to a drop forming nozzle or orifice 47, from which an ink drop 49 is emitted toward a receiver medium 48 that can be a transfer surface, for example.

The ink 33 can be melted or phase changed solid ink, and the electromechanical transducer 39 can be a piezoelectric transducer that is operated in a bending mode, for example.

FIG. 3 is a schematic elevational view of an embodiment of an ink jet printhead assembly 20 that can implement a plurality of drop generators 30 (FIG. 2) as an array of drop generators. The ink jet printhead assembly includes a fluid channel layer or substructure 131, a diaphragm layer 137 attached to the fluid channel layer 131, and transducer layer 139 attached to the diaphragm layer 137. The fluid channel layer 131 implements the fluid channels and chambers of the drop generators 30, while the diaphragm layer 137 implements the diaphragms 37 of the drop generators. The transducer layer 139 implements the piezoelectric transducers 39 of the drop generators 30. The nozzles of the drop generators 30. are disposed on an outside surface 131A of the fluid channel layer 131 that is opposite the diaphragm layer 137, for example.

By way of illustrative example, the diaphragm layer 137 comprises a metal plate or sheet such as stainless steel that is attached or bonded to the fluid channel layer 131. Also by way of illustrative example, the fluid channel layer 131 can comprise a laminar stack of plates or sheets, such as stainless steel.

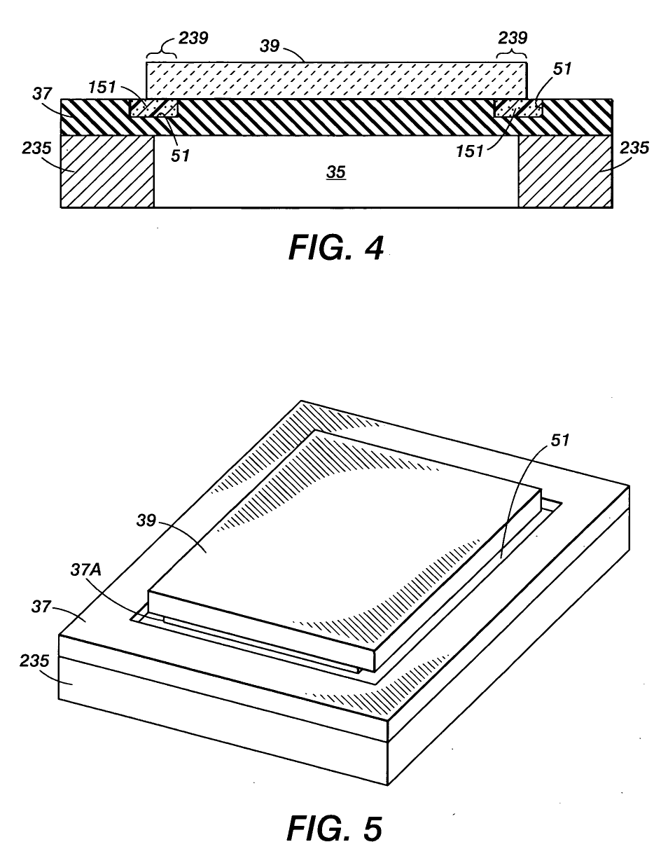

FIG. 4 schematically illustrates an embodiment of a drop generator that includes a pressure chamber 35 defined by chamber walls 235, a diaphragm 37 disposed on the chamber walls 235 and overlying the pressure chamber 35, and a piezoelectric transducer 39 having a bottom surface attached to the diaphragm 37. The diaphragm 37 includes at least one recess, relief, groove, kerf or indentation 51 that is subjacent and underlies an associated edge or peripheral portion 239 of the piezoelectric transducer 39 such that the edge or peripheral portion 239 overhangs or overlies the recess which extends transversely from the transducer beyond the associated edge or peripheral portion. The recess can generally follow a contour of the associated peripheral portion. The recess can partially overlie a portion of the pressure chamber 35.

More generally, the diaphragm includes at least one recess, relief, groove, kerf or indentation 51 that partially underlies a portion of the periphery or outer edge of the piezoelectric transducer such that such portion of the periphery of the piezoelectric transducer overhangs the recess and is not in contact with the diaphragm. The portion of the diaphragm that is in contact with the piezoelectric transducer can be considered an attachment region and comprises an area that is less than the area of the bottom surface of the piezoelectric transducer.

By way of illustrative example, the at least one recess, relief, groove, kerf or indentation 51 can be formed in a diaphragm, which is then attached to the chamber wall. The piezoelectric transducer is then attached to the diaphragm. Alternatively, the recess or recesses can be formed after a diaphragm is attached to the chamber wall. By way of illustrative examples, the recess or recesses can be formed by chemical etching, laser etching, laser ablation, machining, or other suitable process.

Each recess 51 can be filled with a fill material 151 such as a thermoplastic, thermoset, or other elastic or viscoelastic material having a modulus that is less than the modulus of the piezoelectric transducer or diaphragm material.

As illustrated in FIG. 5, an embodiment of the diaphragm 37 can include a single recess 51 that generally follows the entire periphery of the piezoelectric transducer 39 so as to form a closed loop. In such implementation, the piezoelectric transducer 39 is attached to a subjacent island portion 37A of the diaphragm 37. The island portion 37A can completely underlap the piezoelectric transducer 39 such that the entire periphery of the piezoelectric transducer 39 can extend over the single closed loop recess. Also, the island portion 37A of the diaphragm 37 to which the piezoelectric transducer 39 is attached can be completely within a projection of the inner surface of the chamber wall (i.e., within a projection of the outer boundary of the pressure chamber).

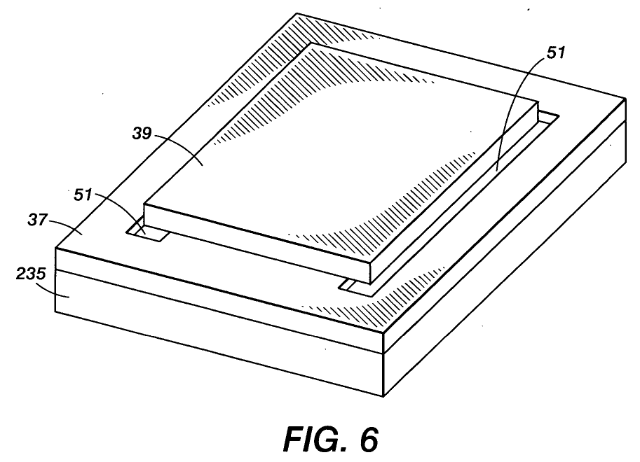

As illustrated in FIG. 6, another embodiment of the diaphragm 37 can include a first recess 51 and a second recess 51 that are generally opposite each other.

Each of the at least one recess 51 can overlie a portion of a chamber wall 235 and a portion of the pressure chamber, whereby the transverse extent of a recess 51 spans a portion of a projection of a subjacent outer boundary of the pressure chamber 35, for example, as generally illustrated in FIG. 4.

By way of further illustrative example, the piezoelectric transducer 39 can extend transversely beyond a portion of a projection of the outer boundary of the associated pressure chamber 35.

The disclosed structure can provide for reduced sensitivity to transducer alignment error, reduced cross-talk between drop generators and reduced firing energy requirements.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. A drop generator comprising:
a pressure chamber defined by a chamber wall structure;
a diaphragm plate disposed on the chamber wall structure and covering the pressure chamber;
a piezoelectric transducer having a bottom surface attached to the diaphragm plate; and
a recess formed in the diaphragm plate and underlying an associated peripheral portion of the piezoelectric transducer such that the associated peripheral portion overhangs the recess.

2. The drop generator of claim 1 wherein the recess extends transversely from the transducer beyond the associated peripheral portion.

3. The drop generator of claim 1 wherein the recess partially overlies the pressure chamber.

4. The drop generator of claim 1 wherein the piezoelectric transducer extends transversely beyond a projection of the pressure chamber.

5. The drop generator of claim 1 wherein the recess generally conforms to a contour of the associated peripheral portion.

6. The drop generator of claim 1 wherein the recess comprises a closed loop that generally follows an entire periphery of the piezoelectric transducer.

7. The drop generator of claim 1 wherein the recess comprises a closed loop that generally follows an entire periphery of the piezoelectric transducer in such manner that the area of the diaphragm in contact with the bottom surface of the piezoelectric transducer is less than an area of the bottom surface.

8. The drop generator of claim 1 wherein the diaphragm comprises metal.

9. The drop generator of claim 1 further including a fill material disposed in the recess.

10. The drop generator of claim 1 wherein the recess is formed by chemical etching.

11. The drop generator of claim 1 wherein the recess is formed by laser ablation.

12. A drop generator comprising:
a pressure chamber defined by a chamber wall structure;
a diaphragm plate disposed on the chamber wall structure and covering the pressure chamber;
a piezoelectric transducer attached to the diaphragm plate; and
a first recess and a second recess formed in the diaphragm plate, each recess underlying an associated peripheral portion of the piezoelectric transducer such that the associated peripheral portion overhangs such recess.

13. The drop generator of claim 12 wherein each of the first recess and the second recess extends transversely from the transducer beyond the associated peripheral portion.

14. The drop generator of claim 12 wherein the first recess and the second recess are generally opposite each other.

15. The drop generator of claim 12 wherein each of the first recess and the second recess partially overlies the pressure chamber.

16. The drop generator of claim 12 wherein the piezoelectric transducer extends transversely beyond a projection of the pressure chamber.

17. The drop generator of claim 12 wherein each of the first recess and the second recess generally conforms to a contour of the associated peripheral portion.

18. The drop generator of claim 12 wherein the diaphragm comprises metal.

19. The drop generator of claim 12 further including a fill material disposed in the first recess and the second recess.

20. The drop generator of claim 12 wherein the first recess and the second recess are formed by chemical etching.

21. The drop generator of claim 12 wherein the first recess and the second recess are formed by laser ablation.

22. A method of making a drop generator comprising:
forming a recess in a diaphragm plate;
attaching a bottom surface of a piezoelectric transducer to the diaphragm plate;
wherein the recess is located so as to underlie a portion of a periphery of the piezoelectric transducer.
